(19) United States
(12) Patent Application Publication
(10) Pub. No.: US 2025/0307899 A1
(43) Pub. Date: Oct. 2, 2025

(54) SYSTEMS AND METHODS FOR INTEGRATING PHYSICAL AND DIGITAL SHOPPING ENVIRONMENTS

(71) Applicant: Shopfulfill IP LLC, Pearl River, NY (US)

(72) Inventors: Shlomo Chopp, Pearl River, NY (US); Ryan Wolfe, Rancho Palos Verde, CA (US)

(73) Assignee: Shopfulfill IP LLC, Pearl River, NY (US)

(21) Appl. No.: 19/091,597

(22) Filed: Mar. 26, 2025

Related U.S. Application Data
(60) Provisional application No. 63/570,141, filed on Mar. 26, 2024.

(51) Int. Cl. G06Q 30/0601; G06Q 30/0201

(52) U.S. Cl. CPC G06Q 30/0631; G06Q 30/0201; G06Q 30/0639

(57) ABSTRACT

Techniques for integrating digital and physical shopping environments are described. In an example, a computer system may receive commerce-related data indicative of a real-time inventory of retail entities and receive user data indicative of an environment of a user. The user data may be obtained by at least one sensor of a user device. The computing system may further input the user data into an AI model and generate, via the AI model, consumer attributes based on the user data. Additionally, the computing system may generate a commerce recommendation with an indication of a product of the real-time inventory. The commerce recommendation may be generated based on at least one feature of the product relating to at least one of the consumer attributes.

### CROSS REFERENCE TO RELATED APPLICATIONS

This application claims the benefit of, and priority to U.S. Provisional Application No. 63/570,141, filed on Mar. 26, 2024, which is hereby incorporated by reference in its entirety for all purposes.

### TECHNICAL FIELD

The present disclosure relates generally to digital shopping and, more particularly (although not necessarily exclusively), to systems and methods for integrating digital and physical shopping environments.

### BACKGROUND

E-commerce has greatly enhanced consumer access and experience through online access to product information, reviews, comparison shopping, prices, and other information. However, due to the vast number of online consumers and E-commerce platforms, it is difficult for systems to track consumer behavior, especially across channels or create targeted advertising. Additionally, there are costly concessions for shipping and returns for retail entities that sell products online. For example, in an event that a product bought online is returned by a consumer, the costs for the retail entity include return shipping, restocking, repackaging, and re-selling the returned product. In contrast, shopping in physical stores provides consumers with immediate access to products. Moreover, because consumers are provided with physical access to the product before purchase, there is typically a lower likelihood of the product being returned. But, product, product information, and pricing and purchase options are far more limited in physical stores than online. Thus, there is a need to integrate online and physical shopping environments such that consumer experience is improved, and retail entity costs are reduced.

### BRIEF DESCRIPTION OF THE DRAWINGS

FIG. 1A is block diagram of an example of a system for integrating physical and digital shopping environments, in accordance with some embodiments of the present invention.

FIG. 1B is another block diagram of the system for integrating physical and digital shopping environments, in accordance with some embodiments of the present invention.

FIG. 1C is another block diagram of the system for integrating physical and digital shopping environments, in accordance with some embodiments of the present invention.

FIG. 1D is another block diagram of the system for integrating physical and digital shopping environments, in accordance with some embodiments of the present invention.

FIG. 2 is a block diagram of an example of a computing system for integrating physical and digital shopping environments, in accordance with some embodiments of the present disclosure.

FIG. 3 is a block diagram of another example of a computing system for integrating physical and digital shopping environments, in accordance with some embodiments of the present disclosure.

FIG. 4 is a block diagram of another example of a computing system for integrating physical and digital shopping environments, in accordance with some embodiments of the present disclosure.

FIG. 5 is a flowchart of an example of a method for integrating physical and digital shopping environments, in accordance with some embodiments of the present disclosure.

FIG. 6 is a flowchart of an example of a method for integrating physical and digital shopping environments, in accordance with some embodiments of the present disclosure.

FIG. 7 is a block diagram of an example of a computing device for integrating physical and digital shopping environments, in accordance with some embodiments of the present disclosure.

### DETAILED DESCRIPTION OF THE INVENTION

Aspects of the present disclosure relate to systems and methods for integrating digital and physical environments for purposes of commerce and shopping. For example, a retail integration system may leverage and in itself be a comprehensive digitally integrated ecosystem that can unify online and offline shopping environments. In doing so, the retail integration system may enable efficient shopping across multiple retailers and informing of the retailers, associated, sellers, and/or associated manufacturers such that their businesses may be more efficient and desirable to shoppers and profitable.

The retail integration system can access, maintain, and/or monitor vast datasets related to retail entities (e.g., individuals or organizations that sell products). As such, the retail integration system can identify products sold by the retail entities, monitor real-time inventory of the products, obtain information indicative of store locations, distribution locations, or the like associated with the retail entities, or obtain other information related to the retail entities. Moreover, the retail integration system may access or monitor vast datasets related to users. The data related to users can indicate hobbies, schedules, financial information (e.g., income and purchase history), clothing style, interior design preferences, or the likes or desires of the users.

The retail integration system may then use the vast datasets related to users and retail entities to unify online and offline shopping experiences. In some examples, the retail integration system can optimize and integrate retail entity's efforts in both the digital and physical world by transforming traditional physical shopping spaces and planning into integrated, intelligent, and digitally enhanced processes and environments. For example, the retail integration system may provide custom commerce recommendations or advertisements to users in real-time during a shopping trip via screens or devices positioned throughout a store location.

Moreover, online and offline shopping components can be integrated and attributed to each other as some actions performed by the user are in-store while other actions may be performed online. For example, a consumer can research a product at home and then go in-store research to purchase the product. The retail integration system may work in the background on the user device to monitor and assist with product research and selection. For example, using the user home videos and/or images, the retail integration system may determine room measurements and then generate and output virtual and augmented reality-based product recommendations via a user device that show products in the room. The retail integration system may further provide navigation for the user to the products or otherwise assist the user in purchasing the product.

In some embodiments, the retail integration system can generate a user profile. This user profile can, in some embodiments, be owned and/or controlled by the user. This ownership and/or control of the user profile can include the location of the user profile on devices owned and/or controlled by the user. In some embodiments, due to user control of the user profile, the user can monetize their own profile and/or their own information. This can include, for example, the user receiving payment and/or compensation for advertisements customized to the user, the user receiving payment and/or compensation for user clicks and/or purchases, or the like.

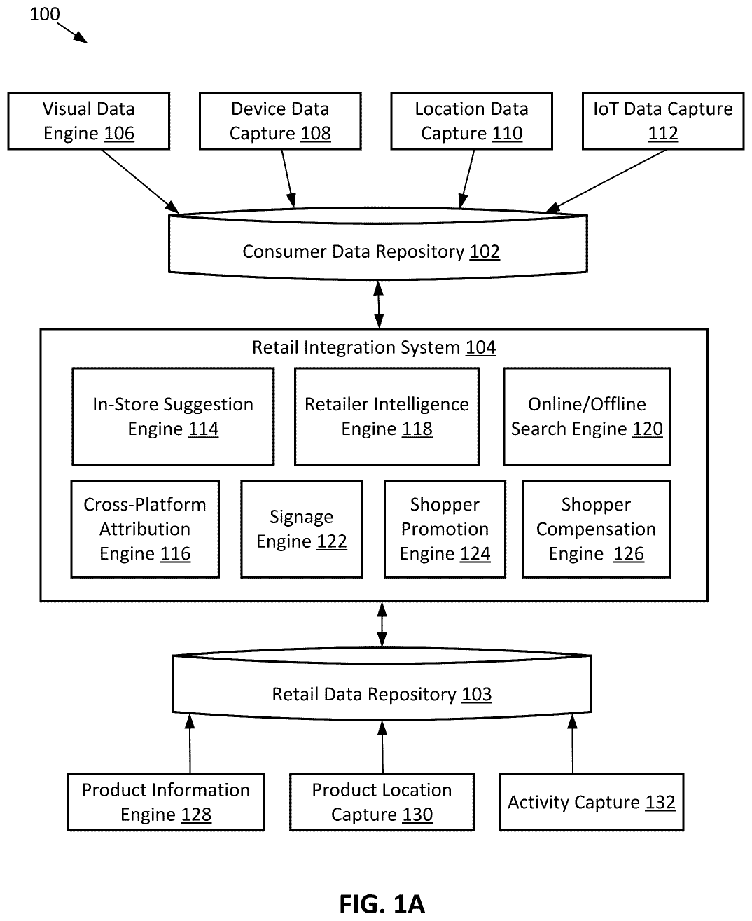

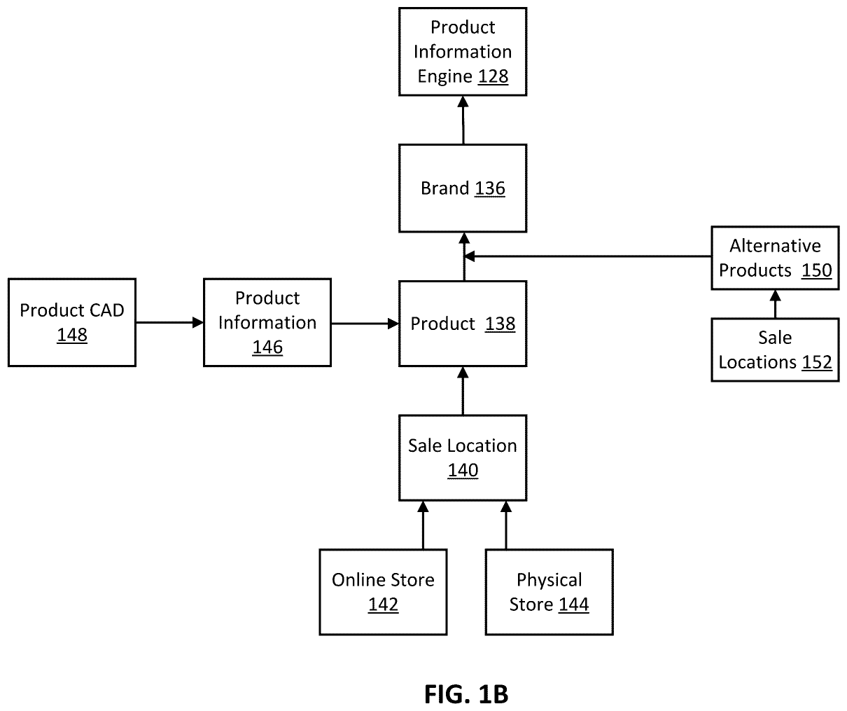

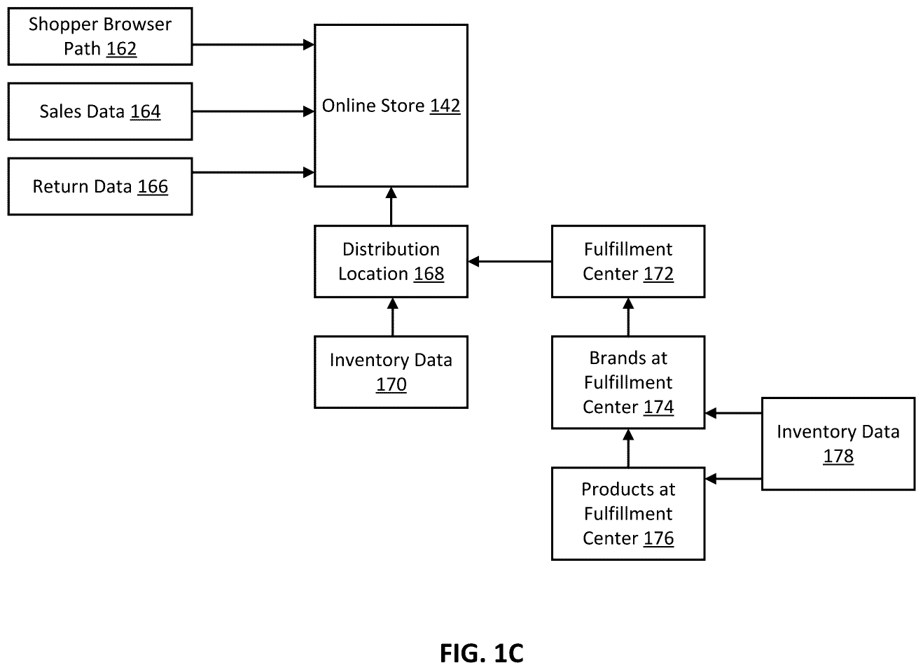

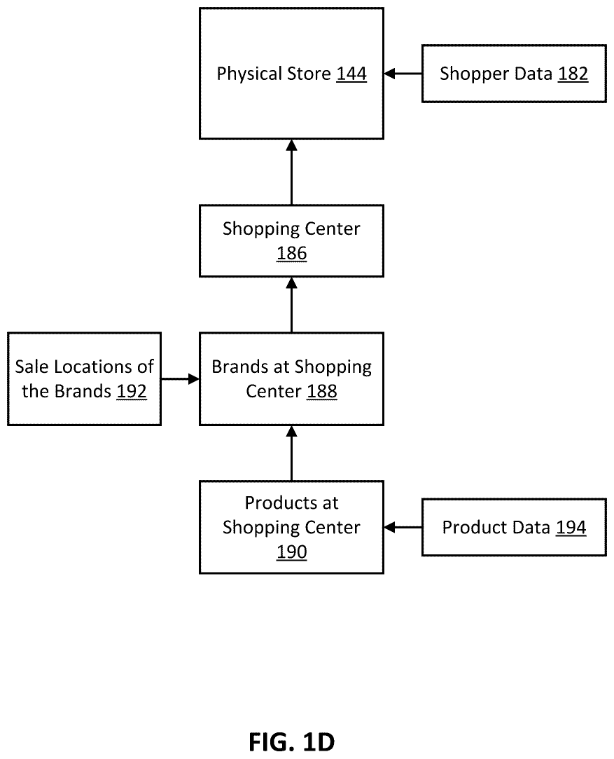

FIG. 1A is block diagram of an example of a system 100 for integrating physical and

digital shopping environments, in accordance with some embodiments of the present invention. The system 100 includes a consumer data repository 102, a retail integration system 104, and a retail data repository 103, which may be communicatively coupled via a network such as a local area network (LAN) or the internet. The retail integration system 104 may utilize data from the consumer data repository 102 and the retail data repository 103 to provide an online environment that integrates seamlessly with online and offline retail environments (e.g., e-commerce platforms and physical shopping malls).

To do so, the retail integration system 104 may detect and process data from the consumer data repository 102 to predict consumer wants and needs. Substantially simultaneously, the retail integration system 104 may detect and process data from the retail data repository 103 to generate and output commerce recommendations to a consumer (also referred to herein as a user) based on the predicted wants and needs of the consumer. Consequently, an improved consumer experience may be provided by the retail integration system 104 providing custom and highly relevant commerce recommendations to consumers. This, in turn, may refine retailer and manufacturers planning, and increase sales and profitability for retail entities (e.g., individuals, organizations, companies, or the like that sell products associated with online and offline retail environments).

To integrate online and offline retail environments, the system 100 may be a distributed computing environment of e-commerce platforms, IoT devices, sensors, or other computing devices used to gather data in physical shopping environments, sensors and other consumer computing devices used to collect data in an environment of a user, other computing devices, or a combination thereof. The collection of data in the environment of the user is discussed in further detail below with respect to visual data engine 106, IoT data capture 112, device data capture 108, and location data capture 110. The collection of data in physical environments is discussed in further detail below with respect to FIGS. 1B and 1D. Moreover, the integration of e-commerce platforms is discussed in further detail below with respect to FIG. 1C.

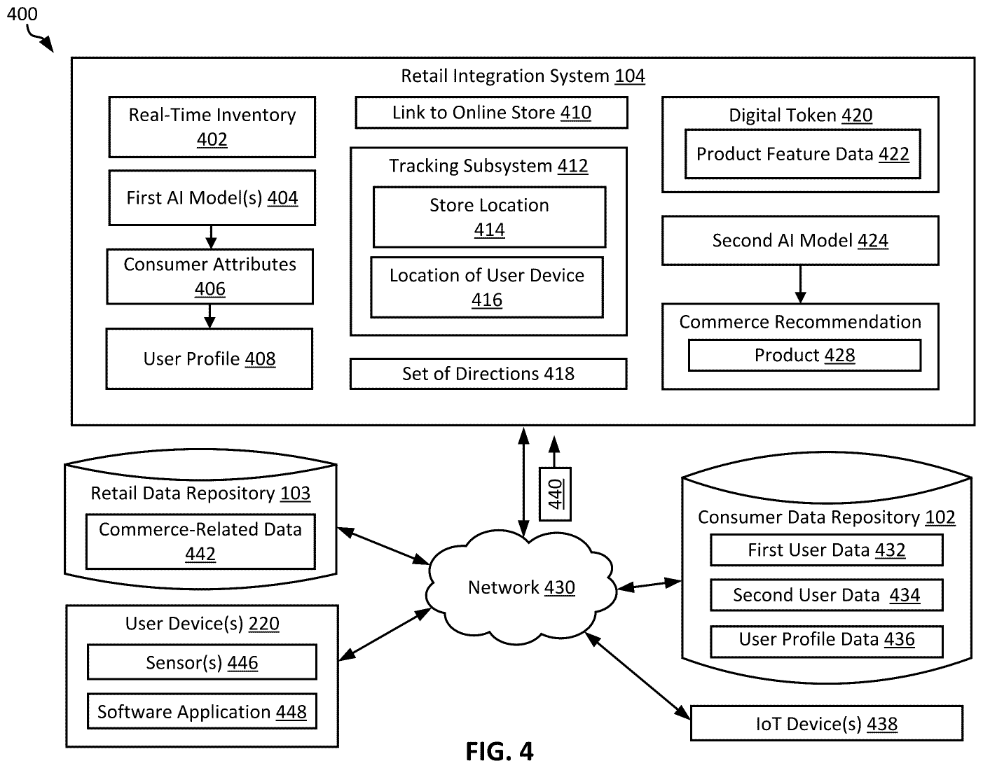

Data in the consumer data repository 102 (e.g., data related to users) and data stored in the retail data repository 103 (e.g., data related to various products of various retail entities) can be processed by the retail integration system 104 to guide a user in real-time with commerce recommendations and to monitor a user's response to such recommendations to further inform one or more AI models. For example, generation and analysis of a user profile and consumer attributes can enable the retail integration system 104 to extrapolate a personal style of the user. Then, the retail integration system 104 may transmit commerce recommendations to a user device of the user based on the personal style. In one example, the retail integration system 104 may transmit the commerce recommendations based on detecting a location, or typical location of the user device as being less than a threshold distance from a physical shopping environment. The physical shopping environment may be a new physical shopping environment that the user may not have located if not for the commerce recommendations. Additional details of the generation and use of user profiles and consumer attributes to provide commerce recommendations is described below with respect to FIG. 4.

The data stored in the consumer data repository 102 may be obtained from many environments of the user, including a home environment, an office environment, a shopping environment, or other locations associated with the user, or associated with similar users (e.g., family members or friends of the user). There may be various data captures and engines that enable collection of data from the various environments associated with the user. The data captures and engines may process raw data from an environment of a user. As a result, the data stored in the consumer data repository 102 may be relevant to and ingestible by the retail integration system 104.

In an example, a visual data engine 106 may capture and process data associated with a user's surroundings, actions, products owned, etc. The data captured and processed by the visual data engine 106 may include images, video data, or the like. For example, the visual data engine 105 may receive a video captured by a user device (e.g., a smart phone) of a living room, an office, or a closet in a home environment of the user.

Computer vision techniques may be employed by the visual data engine 106 to identify objects in the environment of the user from the images, video data, or a combination thereof. Additionally, the visual data engine 106 may identify object attributes from image or video data using the computer vision techniques. The object attributes may include an identification of the object (e.g., whether the object is a couch or a bed), categorization of the object, object characteristics (e.g., color, size, shape, etc.) The categorization of the object may, in one example, be made based on a room in which the object is likely positioned (e.g., a bedroom, living room, office, etc.) In another example, object may be categorized by interior design style or brand. For example, categorizations of furniture may include vintage, modern, and contemporary. In another example, categorization of clothing may include professional, casual, and formal.

Moreover, in some examples, the computer vision techniques may be used by the visual data engine 106 to generate dimensional data related to the environment. The dimensional data may be inferred from an image or video based on pixel information, camera calibration, depth information, or a combination thereof. The dimensional data may include dimensions of the environment (e.g., an estimated square footage of a room), dimensions of the objects identified in the room (e.g., a length, width, and height of a piece of furniture), or a combination thereof. In some examples, the visual data engine 105 may generate a three-dimensional digital model of the environment using the image and video data and insights generated based on the image or video data (e.g., the objects identified, the object attributes identified, and the dimensional data generation).

Additionally, in an example, a device data capture 108 may capture consumer data device actions, website actions, or the like. For example, the device data capture 108 may access analytics related to visits to websites by a user on one or more user devices (e.g., a laptop, smartphone, tablet, etc.). Examples of the analytics include which pages of the website were visited by the user, how much time the spent on the website, and a type of device and browser used to access the website. The device data capture 108 may further access analytics related to the consumer data device actions. For example, the data may compare time spent by a user on each of a set of consumer devices (e.g., a laptop, a smartphone, and a tablet). Additionally, or alternatively, the data may indicate how much time the user spends on each software application downloaded on each user device.

In another example, a location data capture 110 may capture consumer location data, travel route data, etc. For example, the consumer location data may include locations at which a user device is positioned. The consumer location data may specifically include coordinates, a zip code, a city, other indications of location, or a combination thereof for the user device. The consumer location data may further include metrics indicative of which locations the user device is positioned at most often. The travel route data may be continuously gathered consumer location data such that the travel route data is indicative of a path of transportation of a user based on a path of transportation of a user device. The travel route data may further include details of the path of transportation such as an original location, a destination location, a distance and route traveled between the original location and the destination location, travel time, etc.

Moreover, in some examples, an IoT data capture 112 may communicate with IoT devices in environments of the user to capture data from the IoT devices. The IoT devices may include smart home devices such as smart thermostats, smart locks, smart appliances, and smart TVs. Additionally, the IoT devices may include wearable devices such as fitness trackers and smartwatches, personal-assistant devices (e.g., Amazon Echo and Google Home), or the like. The data captured from the IoT devices can provide additional context to consumer behavior. For example, the wearable devices may indicate hobbies or activities performed by the user. In some embodiments, the IoT data capture 112 can include information captured from a WiFi network and/or from devices connected to a WiFi network. This can, in some embodiments, include use of information generated based on WiFi signals and/or data gathered or generated from WiFi signals. This can include, for example, information relating to human movement patterns through a room, information relating to room dimensions, information relating to locations and/or dimensions of objects in a room, information relating to presence, movement, and/or size of pets, or the like.

The data stored in the retail data repository 103 may be obtained from online and offline (e.g., physical) retail environments. There may be various data captures and engines that enable collection of data from the online and offline retail environments. The data captures and engines may process raw data from the online and offline retail environments. As a result, the data stored in the retail data repository 103 may be relevant to and ingestible by the retail integration system 104.

In some embodiments, the retail data repository 103 can be located on a user device and/or can be located on a device owned and/or controlled by the user. In some embodiments, this can include the storage of the retail data repository in an online and/or cloud location controlled and/or assigned to the user. In some embodiments, this control can allow the user to determine when, why, and/or how the user's information is used. In some embodiments, this can further include allowing the user to profit from use of the information contained in the retail data repository 103. This can include, for example, controlling the use of information in the retail data repository 103 to provide one or several advertisements and/or recommendation to the user and/or controlling the accrual of benefits from use of information in the retail data repository 103.

In an example, a product location capture 130 may capture product location data. The product location capture 130 may access a tracking device affixed to a product to obtain product location data. Tracking products to capture product location data is described is further detail below with respect to FIG. 4. Moreover, an activity capture 132 may capture data related to visitors of retail entities and purchases made from the retail entities. For example, the activity capture 132 may obtain data indicative of how many times a product has been purchased, how many times the product has been returned, an average rating of the product as provided by consumers in online reviews, etc. Moreover, the activity capture 132 may obtain user data associated with consumers that may have purchased, returned, or not returned the product.

Additionally, a product information engine 128 may capture information on products from various retail entities that can be purchased by consumers. FIG. 1B shows an example of the data obtained by the product information engine 128. Although FIG. 1B shows an example of data associated with a product 138, it should be appreciated that the product information engine 128 may obtain data for any number of products associated with any number of retail entities.

As shown in FIG. 1B, the product information engine 128 may receive a product computer aided design (CAD) 148. The product CAD 148 may be a two-dimensional or three-dimensional model of the product 138. The product information engine 128 may further receive product information 146 for the product 138. The product information 146 may include any characteristics of the product 138. For example, the product information 146 may include an identifier (e.g., a name) of the product 138, key words associated with the product 138, functionality of the product 138, dimensions of the product 138, a place of manufacture for the product 138, materials or other designs features of the product 138, a price of the product 138, etc.

Additionally, the product information engine 128 may receive a store location 140 of the product 138. The store location 140 may be an online store 142, a physical store 144, or a combination thereof. Additional information associated with the store locations 140 are described below with respect to FIGS. 1C and 1D, respectively. The product information engine 128 may further receive alternative products 150 that are similar to the product 138. For example, if the product is a white couch, the alternative products can be other white couch or sofa options. In another example, the retail integration system may determine, based on processing user data, that a love seat and a table would fit user habits (e.g., often using a seat in a living room to read) and a user environment (e.g., the living room) better than a white couch. Thus, the alternative products may include love seats and tables or other products the retail integration system deems useful for the user. The product information engine 128 may receive information related to the sale locations 152 of the alternative products as well.

Moreover, the product information engine 128 can receive a brand 136 of the product. In some examples, the product information engine 128 may also receive alternative brands that have similar products (e.g., brands of the alternative products 150). Moreover, in some examples, the product information engine 128 may receive a retail entity associated with the product 138 (e.g., an organization or company that is selling the product 138), which may or may be distinct from the brand 136.

FIG. 1C shows additional data that the product information engine 128 may receive when the store location 140 is an online store 142 (e.g., an e-commerce platform or website). For example, FIG. 1C shows a shopper browser path 162 which may be a series of links or searches that lead the user finding the product 138 in the online store 142. Additionally, the product information engine 128 may collect sales data 164, return data 166, or a combination thereof from the online store 142. The sales data 164 may indicate how many times the product 138 has been purchased via the online store 142 while the return data 166 may indicate how many times the product 138 has been returned to the online store.

Additionally, the product information engine 128 may receive data indicative of a distribution location 168, a fulfillment center 172, or a combination thereof at which the product may be stored. The distribution location 168 may be a location from which the product can be shipped to a physical store location while the fulfillment center 172 may be a location from which the product can be shipped directly to a user. A physical store location may also be a location from which the product can be shipped directly to a user. The product information engine 128 may further receive inventory data 170 for the distribution location and/or inventory data 178 for the fulfillment center 172. The inventory data 170 for the distribution location 168 may include a number of the product 138 stored at the distribution location 168. The inventory data 170 may further indicate other products stored at the distribution location 168. Similarly, the inventory data 178 for the fulfillment center 172 may include a number of the product 138 stored at the fulfillment center 172. The inventory data 178 may further include data indicative of other brands 174 and of other products 176 at the fulfillment center 172.

In some embodiments, items within a store can be coupled and/or associated with an active tag, which active tag can communicate with one or several sensors and/or user devices within a store to provide real-time information relating to the presence and/or location of the items within the store. In some embodiments, these on or several active tags can include, for example, an RFID tag, and NFC tag, a Bluetooth-enabled tag, or the like. In some embodiments, and based on information received from the active tag, the real-time location of items within the store can be identified and tracked and provided to the retail data repository 103.

FIG. 1D shows additional data that the product information engine 128 may receive when the store location 140 is a physical store 144. For example, the product information engine 128 may receive a location (e.g., an address) of the physical store 144, a shopping center 186 (e.g., a name of a mall) in which the physical store 144 is located, and shopper data 182. The shopper data 182 may include metrics indicative of how many shoppers are at the physical store, how many shoppers have bought the product 138 from the physical store 144, how many shoppers have returned the product 138 to the store, etc.

Additionally, the product information engine 128 may receive data indicative of other brands 188 at the shopping center 186 and locations 192 indicative of the physical stores in the shopping center 186 at which the brands 188 are sold. Moreover, the product information engine 128 may receive data indicative of other products 190 at the shopping center 186 and product data 194 for the products 190 (e.g., location data indicative of the physical stores in the shopping center 186 at which the products 190 are sold and/or a price, color, dimensions, or other descriptive data for the products 190).

The retail integration system 104 may include various engines that facilitate various functions of and use-cases associated with the retail integration system 104. The engines may utilize any of the data in the retail data repository 103 and the consumer data repository 102 to facilitate the various functions of and use-cases associated with the retail integration system 104. For example, an in-store suggestion engine 114 may leverage data obtained by the product information engine 128 (e.g., location data for products and shopper data) to generate commerce recommendations to a user in real time during a shopping trip (e.g., while the user is in a physical store). The in-store suggestion engine 114 may further guide users in navigating products and aisles in a physical store. For example, the in-store suggestion engine 114 may generate alerts and transmit the alerts to a user device. The alerts may include a commerce recommendation with a product, product data for the product, location information for the product (e.g., an aisle the product in positioned in), etc. In some embodiments, and based on real-time information gathered from active tags, the in-store suggestion engine 114, which may receive information from one or more of the other engines, can guide a user to the real-time location of one or several items, as opposed to just guiding the user to the planned and/or designated location of the one or several items.

Additionally, the retail integration system 104 may include a cross-platform attribution engine 116. The cross-platform attribution engine 116 may analyze online and offline actions of the user (e.g., actions indicated by data obtained from user devices and IoT devices in an environment of the user) to understand a user's day-to-day life, shopping habits, interests, or the like. The cross-platform attribution engine 116 may further analyze purchases and both in store and online actions made by the user and other user data to improve generation of custom commerce recommendations made to the user. Moreover, a retail intelligence engine 118 can inform of inventory and product placement for various products sold by various retail entities. To do so, the retail intelligence engine 118 may communicate with inventory management systems, planning systems, manufacturers, retailer APIs, or the like to update them and to obtain up-to-date inventory and product information from the various retail entities.

An online/offline search engine 120 of the retail integration system 104 may leverage product and user data from the retail data repository 103 and the consumer data repository 102 respectively to provide highly relevant and custom results in response to queries from users. The online/offline search engine 120 may be associated with a generative AI model trained to generate text, images, videos, or a combination thereof in response to user queries (e.g., natural language queries).

A signage engine 122 may also leverage the product and user data from the retail data repository 103 and the consumer data repository 102 respectively, but to provide highly relevant and custom advertisements to individual users or groups of users. For example, the signage engine 122 may obtain (e.g., generate or receive) data indicative of a period of time that one or more consumers spent with a threshold distance of a sign with an advertisement. Additionally or alternatively, the signage engine 122 may determine effectiveness of previous signage for users. For example, the signage engine 122 may compare purchases made by the user to advertisements provided to the user and/or to advertisements the user spent time near. The signage engine 122 can then use such information to learn consumer preferences and improve advertising strategies. The signage engine 122 can further determine an advertisement to show based on the preferences and habits of nearby user. The shopper promotion engine 124 may leverage the product and user data to similarly promote particular products to users. Moreover, a shopper compensation engine 126 may monitor user activities and facilitate payments between users and retail entities.

The above engines may enable the retail integration system 104 to provide personalized shopping and recommendations. For example, the in-store suggestion engine 114, which may integrate retail entity, brand, product, inventory, and user data, can provide tailored guidance, advice, and product suggestions throughout a shopping journey of a user. In one particular example, location data from a user device can indicate a user is in a physical shopping location. The user may open a software application executing on the user device and associated with the retail integration platform while the user is in the physical shopping location. The user device may transmit a request for in-store product suggestions upon the opening of the software application or due to the user device being in the physical shopping location. The in-store suggestion engine 114 may input the data for one or more retail entities associated with the physical store location (e.g., data indicative of brands and products sold by the retail entities), inventory data for the physical store location, and user data to an AI model. The AI model system may then output personalized shopping recommendations for the user based on the input.

In some examples, the engines can enable the retail integration system 104 to provide a unified shopping platform that enables consumers to identify and shop products physically located within a region (e.g., within a threshold distance from a home address of a user). For example, the online/offline search engine 120 can provide products within the region in response to user queries. Thus, the retail integration system 104 can enable personalized wayfinding across a shopping center and retail network related to the user (e.g., physically located relatively close to the user).

Moreover, the retail integration system 104 can provide AI-powered virtual shopping assistants and stylists. The retail integration system 104 may utilize a large language model to provide a shopping assistant that can recommend products, plan shopping trips, estimate a time of the shopping trips, or otherwise assist users with shopping. Additionally or alternatively, the retail integration system 104 may utilize a large language model to provide a virtual stylist. The virtual stylist can provide, via the large language model, recommendations for jewelry, clothing, or the like to style a user. In other examples, the virtual stylist may provide, via the large language model, recommendations for furniture, decorations, art, or the like to style an environment of the user (e.g., a living room, bedroom, or the like).

The above engines can further enable the retail integration system 104 to provide immersive and personalized shopping experiences. To do so, retail integration system 104 can further leverage including proximity sensors (e.g., those associated with IoT devices), augmented reality, and spatial computing to create custom, in-store or home experiences that bridge online and physical interactions. For example, the retail integration system may facilitate virtual try-ons and product visualizations for a user while in a physical store. The virtual try-ons and/or product visualizations can be performed using AR/VR technologies. There may further be interactive product discovery stations in physical store locations that the retail integration system 104 can control to provide detailed information and reviews for products to users.

The retail integration system 104 can further enable unified inventory management and supply chain optimization for retail entities. For example, the retail integration system 104 can perform real-time inventory tracking for many retail entities across many locations by tracking products and/or receiving information from inventory management systems or retailer APIs. As a result, the retail integration system 104 can provide real-time inventory visibility across many stores and warehouses. Moreover, the retail integration system 104 can perform predictive analytics related to inventory. For example, the retail integration system 104 may predict a consumer demand for a product based on sales data and consumer trends, and provide such information related to consumer demand to a retail entity to assist the retail entity with inventory management.

By enabling the unified inventory management and supply chain optimization for retail entities, the retail integration system 104 may further facilitate on-demand and just-in-time manufacturing and warehouse dispatch for rapid replenishment, pick-up, and delivery. For example, based on predictive analysis of consumer trends and sales data, the retail integration system 104 can transmit a request for more of a product to be shipped to a store location. Moreover, by providing real-time inventory visibility across many stores and warehouses, the retail integration system 104 can perform cross-store inventory sharing and analysis to maximize knowledge of product availability.

The retail integration system 104 can also provide data-driven insights to users and to retail entities. For example, the retail integration system 104 can collect and use user data to predict consumer trends, behaviors, and desires. In other words, the retail integration system 104 can utilize predictive consumer behavior modeling for strategic decision-making. The retail integration system 104 may then optimize physical store layouts, pricing strategies, product placement and groupings, and marketing efforts based on the consumer trends, behaviors, and desires. For example, the retail integration system 104 may track user devices or use in-store cameras to generate heat maps or another visualization of customer movement patterns. The retail integration system 104 may then analyze and compare the customer movement patterns to online movements (e.g., consumer browser paths), and may generate physical store layouts, pricing strategies, product placement and groupings, and marketing efforts based on the comparison.

For pricing strategies, the retail integration system 104 may generate and implement dynamic pricing algorithms that use consumer demand and inventory levels, on a user and/or market level, to determine prices of products. For product placement, the retail integration system 104 may execute AI models trained to predict optimal product placement based on market and shopper preferences. The retail integration system 104 may also be able to provide immersive real-time advertising across shopping centers, stores, or product shelfs. The advertising may be customized to a user or group of users present. For example, the retail integration system 104 can facilitate production and output of custom advertisements on a screen in a front part of a store based on detecting a user walking into the store and based on user data associated with the user.

The retail integration system 104 may unify digital and physical shopping environments to provide a consistent, integrated shopping journey for users. For example, the retail integration system may provide a centralized payment platform that services more than one retail entity (e.g., all retail entities in a shopping center and associated online stores). The centralized payment platform can thereby enable unified shopping carts and checkout processes across the retail entities. In this way, a user may add products from any of the retail entities to a singular shopping cart and may pay for products from multiple retail entities in a singular check out process. In physical store environments, the retail integration system 104 may facilitate check out stations at which a user can purchase products from multiple retail entities.

The retail integration system 104 may also provide extended reality (AR/VR) home shopping experiences. For example, an extended reality environment can mimic a physical store location, thereby enabling the user to shop the physical store location from home. Additionally, the retail integration system 104 can provide intelligent systems and automation to enhance efficiency, safety, and theft reduction within the shopping environment. For example, the retail integration system 104 can implement AI-driven computer vision for security, crowd management, store associate cues, and contactless interactions.

In some examples, a consortium blockchain is the central integrated data warehouse for all retail and consumer data (e.g., any of the data described above with respect to the consumer data repository 102 and the retail data repository 103). The blockchain technology may enable product authenticity and supply chain visibility. Proximity, motion, and image sensors may further enhance the use and source of data on the consortium blockchain. The blockchain can use or access API interfaces to unite data across the ecosystem, smart shelf labels with real-time pricing and stock information, augmented reality wayfinding and product information overlays, or a combination thereof.

Moreover, in some examples, the retail integration system 104 can execute a unified loyalty and engagement platform. The unified loyalty and engagement platform may create a cohesive loyalty ecosystem associated with more than one retail entity that incentivizes consumer engagement and fosters long-term brand and shopping center affinity across the retail entities. The loyalty and engagement platform may provide omnichannel loyalty programs with personalized rewards and offers for consumers, location-based promotions and push notifications for in-store engagement, gamified loyalty experiences with social sharing and community elements, integration of wearable devices for seamless loyalty tracking and redemption, or a combination thereof.

In some examples, the retail integration system 104 may further include a privacy and data compensation system. The privacy and data compensation system can execute payments to consumers for their data and may return ownership of data to the consumer rather than feeding the data to advertising businesses. In some embodiments, this can include automatic brokering of user of user information with one or several entities utilizing this information. This can include brokering use of the user information to customize one or several advertisements, recommendations, and/or the like. In some embodiments, this brokering can be performed via one or more AI agents controlled by the user and configured to monetize, according to one or more user preferences, the user information.

Now turning to a particular example, a software application associated with the retail integration system 104 may be executing on a user device of a user (e.g., a smartphone). The software application can obtain user data via sensors on the user device. For example, with the software application on one or more user devices, lidar sensors, cameras, and other sensors associated with the user devices can be used to scan a closet, home, office, vacation home, or other environments associated with the user to generate user data. As a result, the user data can include furnishing measurements and other items and data. The software application may then transmit the user data to the retail integration system. Additionally or alternatively, a sizing application and or user data analysis may further enable cataloging of the user's appearance (e.g., of the user's height, weight, body measurements, hair color, eye color, etc.). A health application may also provide user data of the user's activities and vitals, and such user data can be obtained by the retail integration system 104 from the health application. The retail integration system 104 may further access bookkeeping, credit cards, and the like to generate user data indicative of purchases by the user.

The retail integration system can use AI models to generate consumer attributes based the user data. The consumer attributes can relate to various aspects of the user's lifestyle. For example, from the user data, the consumer attributes generated can be indicative of shopping preferences of the user, details of a physical environment of the user, or the like. As a result of obtaining user data and generating consumer attributes, the retail integration system can catalog interests of the user, a layout of the user's home and office to the dimensions, styles of the user's furniture, and various other information. As a result, the retail integration system generate and output recommendations that are not only desirable for the user but suited to the user's environment and/or interests.

Additionally, based on the user data and consumer attributes, the retail integration system 104 can generate a user profile for the user. The user profile may be a rich tapestry of data that categorizes and extends beyond consumer habits. For example, the user profile may integrate financial information (e.g., transactions, income, etc.) to paint a comprehensive picture of a purchasing behavior of the user. Additionally, the user profile can contain information indicative of a daily routine, past activities, frequented locations, homes, rooms and possessions as well as recorded preferences of the user. The user profile may further integrate and be enhanced by data from the health application on the user device. For example, any commerce recommendations provided in real-time to the user can be based on a wellness journey or workout habits of the user. The user profile and commerce recommendations provided by the retail integration system 104 can be further enhanced by the retail integration system 104 accessing user profiles and/or user data associated with the user's family members.

Over time, through action and data tracking as well as consumer attributes, user data, and user profile generation for the user as and for other users, the retail integration system can anticipate and respond to user requests for shopping assistance. The retail integration system can further recommend products and schedule store visits based on the user's interest, schedule, and travels. For example, the retail integration system may seamlessly integrate with a calendar application on the user device to optimizing shopping schedules and ensuring that product suggestions are timely and contextually relevant to the user. In another example, the retail integration system may suggest products and experiences that are relevant to and enhance upcoming events for the user. The retail integration system may do so by outputting a digital manifestation of the products on the user device. Moreover, the suggestions may be provided via virtual reality previews that allow the user to visualize products in the environment of the user. for example, the virtual reality preview may allow the user to visual decor for an upcoming birthday celebration in a room of the user's home.

The retail integration system 104 can further permeate a physical world of the user. For example, as the user walks through a city, the retail integration system can cause digital billboards to adapt to the preferences of the user or of a combination of the user and other users nearby. In this way, the retail integration system can offer personalized advertisements that are relevant and engaging.

Additionally, the retail integration system 104 can recommend and guide the user to a retail location with relevant products in stock, throughout the user's otherwise typical, daily route. A virtual store assistant of the retail integration system 104 can interface with the user to present relevant products and can provide answers to product-specific questions. The retail integration system 104 can also order a selection of products (with or without a user request) to facilitate the products being ready for review by the user upon reaching the store.

Moreover, based on comparison of purchases and recommendations, the retail integration system 104 can log which recommendations and/or advertisements have impact on the user and those that do not. Over time, the retail integration system 104 can learn from the logs to improve recommendations and advertisements generated for the user. Moreover, a mechanism that provides cash back to consumers for purchases and pays for advertising can be built into the retail integration system 104. Thus, the user may be compensated for sharing data with the retail integration system 104.

The retail integration system 104 can therefore both predict a demand of the user for products and organize the shopping for the products into a daily life of the user. Accordingly, through the retail integration system 104, a unique and efficient shopping experience that is predictive, personalized, and seamlessly integrated into the daily life of the user can be provided.

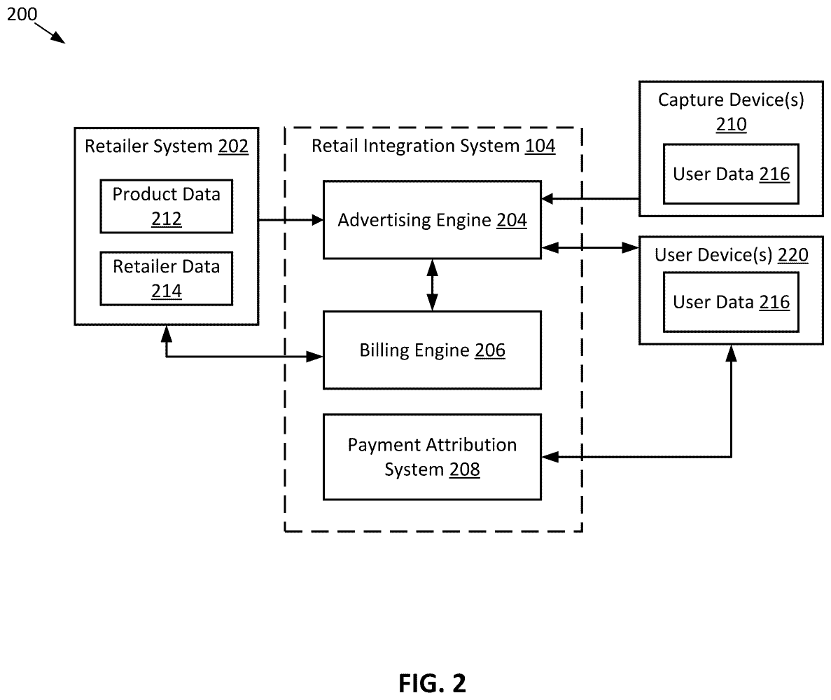

FIG. 2 is a block diagram of an example of a computing system 200 for integrating physical and digital shopping environments, in accordance with some embodiments of the present disclosure. In particular, FIG. 2 shows the retail integration system 104 communicatively coupled with capture devices 210, user device(s) 220, and retailer system 202. The capture devices 210 may be any device or sensor in an environment of a user from which the retail integration system 104 can obtain user data. For example, the capture devices 210 correspond to the IoT devices 438 shown and described below with respect to FIG. 4.

As shown, an advertising engine 204 of the retail integration system 104 can receive user data 216 from the user devices 220 and/or capture devices 210. The advertising engine 204 may further receive product data 212 from the retailer system 202, which may indicate products a retailer entity associated with the retailer system 202 is selling and details of the product (e.g., price, size, color, etc.). The advertising engine 204 may further receive retailer data 214 from the retailer system 202, which may provide information about the retail entity (e.g., a name of the retail entity, types of products the retail entity sells, store locations of the retail entity, etc.). Using the user data 216, the product data 212, and the retailer data 214, the advertising engine can generate and transmit commerce recommendations and advertisements to the user devices 220.

The retail integration system may bill the retail system 202 via the billing engine 206 for the commerce recommendations and advertisements. Moreover, the retail integration system 104 may transmit payments to the user devices 220 in return for the use of the user data 216 to generate the commerce recommendations and advertisements.

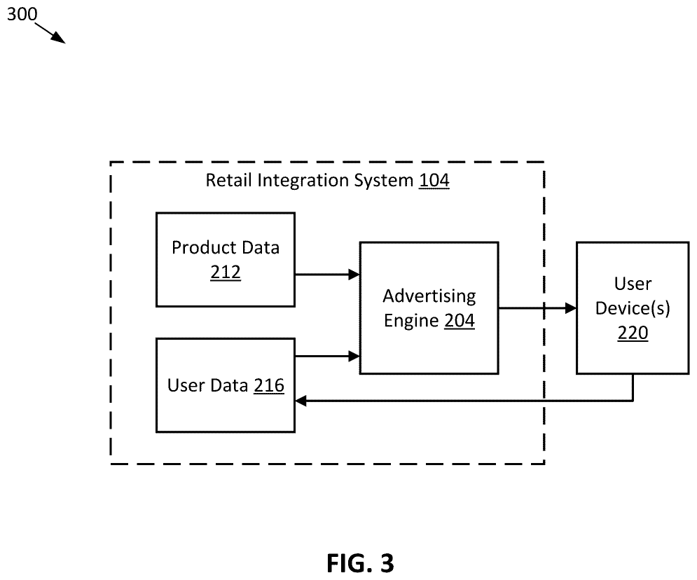

FIG. 3 is a block diagram of another example of a computing system 300 for integrating physical and digital shopping environments, in accordance with some embodiments of the present disclosure. FIG. 3 shows the advertising engine 204 receiving product data 212 and user data 216 and transmitting commerce recommendations and/or advertisements to the user device(s) 220.

FIG. 4 is a block diagram of another example of a computing system 400 for integrating physical and digital shopping environments, in accordance with some embodiments of the present disclosure. The computing system 400 may be a distributed computing environment that includes the retail integration system 104, the consumer data repository 102, the user device(s) 220, and IoT device(s) 438. The retail integration system 104, the consumer data repository 102, the user device(s) 220, and the IoT device(s) 438 may be communicatively coupled via a network 430 (e.g., such as the Internet or other suitable wide area network). Examples of the user device 220 include a smart phone, a tablet, a personal computer, a laptop, other suitable devices, or a combination thereof. Examples of the IoT device 438 include smartwatches, fitness trackers, smart appliances, smart TVs, security systems, other suitable IoT devices, or a combination thereof. The retail integration system 104 may be a server-based service that may, among performing other operations, use the commerce-related data 442 and user data to provide commerce recommendations.

A software application 448 may be executing on the user device 220. The software application 448 may provide a user of the user device 220 with access to features and functionality of the retail integration system 104 (e.g., access to custom commerce recommendations). A user may create an account on the software application. In doing so, the user may provide personal data (e.g., a name, address, email, financial information such as income, etc.). The user may further provide information related to retail preferences. Information related to retail preferences may include brand preferences, product preferences, art preferences, interior design style preferences, color preferences, interests of the user (e.g., sports, hobbies, or the like), etc. The retail integration system 104 may receive user profile data 436 from the software application 448. The user profile data 348 may include the personal data, the information related to retail preferences, or other information input by the user to the software application 448 via the user device 220.

Additionally, via the software application 448 executing on the user device 220, the retail integration system 104 can capture first user data 432 relating to an environment of the user. The environment of the user may be a part of a home of the user (e.g., a living room, closet, dining room, bathroom, bedroom, kitchen, or backyard), an office space used by the user, or another location in which the user device 220 can be positioned to obtain data. Moreover, in some examples, the user may be part of the environment of the user. For example, the first user data 432 may be one or more videos or images of the user standing in a room.

The retail integration system 104 may use the sensor(s) 446 (e.g., a camera, a microphone, or LiDAR sensors) of the user device 220 to capture the first user data 432. The first user data 432 may automatically be captured. For example, the software application 448 may automatically and continuously obtain the first user data 432 captured via the sensors of the user device 220 and transmit the data to the retail integration system 104. Alternatively, the first user data 432 may be captured based on a user input. For example, the user input may be an uploading of video data or images to the software application 448. In another example, the user input may be a selection of an option in the software application 448 that causes the software application 448 to access the sensors 446 (e.g., the camera) and collect the first user data 432 (e.g., video data) of the environment of the user (e.g., of a home of the user).

The retail integration system 104 can also capture second user data 434 relating to an environment of the user from the IoT device(s) 438. To do so, the retail integration system 104 may use network scanning tools, analyze network traffic, examine Dynamic Host Configuration Protocol (DHCP) logs, or perform another IoT device detection technique to detect the IoT devices 438 associated with the network 430. The IoT devices 438 may include smart home devices such as smart thermostats, smart locks, smart appliances, and smart TVs. Additionally, the IoT devices may include wearable devices such as fitness trackers and smartwatches, personal-assistant devices (e.g., Amazon Echo and Google Home), connected vehicles, etc. After detecting the IoT devices 438, the retail integration system 104 may request data from the IoT devices 438 using, for example, application programming interface (API) calls or another communication protocol.

The data captured from the IoT devices can provide additional context to consumer behavior of the user. For example, the second user data obtained from a wearable device worn by the user may be workout data, which may include a type of a workout (e.g., run, yoga, or weight lifting), a duration of the workout, and location data obtained during the workout. Additionally or alternatively, the second user data obtained from the wearable device worn by the user may be a step count for a period of time (e.g., 24 hours), heart rate data, sleep data, or a combination thereof. Such data may indicate a schedule of the user, an activity level of the user, and/or hobbies or activities performed by the user. In another example, the second user data obtained from a smart TV in the user's home may include viewing history data and user pathway data (e.g., data indicative of how a user interacted with the smart TV, where the user interaction may include launching apps or searching for content). Such data may indicate interests of the user.

Upon receiving the first user data 432, the second user data 434, the user profile data 436, or a combination thereof, the retail integration system 104 may evaluate the first user data 432, the second user data 434, the user profile data 436, or the combination thereof to identify (e.g., extract) consumer attributes 406. The retail integration system 104 may evaluate the first user data 432, the second user data 434, the user profile data 436, or the combination thereof by inputting the first user data 432, the second user data 434, the user profile data 436, or the combination thereof into one or more artificial intelligent (AI) models (e.g., first AI model(s) 404).

In an example, the consumer attributes 406 may relate to an appearance of the user. Consumer attributes related to appearance may include height, weight, body dimensions, skin color, hair color, eye color, or the like. In the example, an AI model may be trained on training data that is obtained using similar sensors as those associated with user device 220 and/or the IoT devices 438. For example, the training data may include video data, images, or a combination thereof of people. Additionally or alternatively, the training data may include biometric data (e.g., sleep data, heart rate data, etc.), clothing size data, or other suitable data indicative of the consumer attributes related to appearance. The training data can further be annotated with consumer attributes related to appearance (e.g., height, weight, skin color, etc.). As a result of training, the AI model can detect patterns and features in images, videos, and other data that are indicative of various consumer attributes related to appearance. Thus, as a result of training of the AI model with the training data, the AI model can output the consumer attributes related to the appearance of the user. The AI model may specifically output the consumer attributes related to the appearance of the user in response to receiving an input with at least a portion of the first user data 432, the second user data 434, the user profile data 436, or the combination thereof.

In another example, the consumer attributes 406 may identify clothing style characteristics of clothing that the user owns or desires. The clothing style characteristics may include one or more clothing styles (e.g., preppy, casual, professional, etc.), clothing types (e.g., jeans, dresses, t-shirts, etc.), clothing colors, and/or clothing fits (e.g., form-fitting, tailored, oversized, etc.). In such an example, an AI model may be trained using training data that includes videos, images, or a combination thereof of clothing and/or of the clothing being worn. The data may be annotated with a type of clothing, a style of the clothing, a color of the clothing, a fit of the clothing, or a combination thereof. As a result of the training the AI model using the training data, the AI model can detect clothing style characteristics from images and/or videos of clothing. Therefore, if, in an example, video data and/or images of a closet of the user or of clothes the user owns are input into the AI model, the AI model can output the consumer attributes that identify clothing style characteristics of the user.

In another example, the consumer attributes 406 may relate to an interior design of an environment of the user (e.g., of an office space, a part of a home, etc.). Consumer attributes related to an interior design of an environment may include a decoration style (e.g., minimalist, midcentury modern, bohemian, etc.), furniture colors, paint colors, wood types, or the like. In such an example, an AI model may be trained using training data with video data, images, or a combination thereof of various furniture, decorations, and furnished and/or decorated rooms (e.g., offices, bedrooms, bathrooms, living rooms, etc.). The training data may be annotated with consumer attributes related to interior design. As a result of the training the AI model with the training data and in response to receiving the at least a portion of the first user data 432, the second user data 434, or the combination thereof, the AI model can output the consumer attributes related to interior design of the environment of the user.

In yet another example, the consumer attributes 406 may relate to actions performed by the user. For example, the consumer attributes may include an average amount of time a user spends at a location, a comparison of an amount of time the user spends indoors versus outdoors, a local climate, a local season, activities, sports, or hobbies performed by the user, etc. The consumer attributes related to actions performed by the user may also indicate e-commerce platforms or other websites or platforms (e.g., social media platforms) used by the user, shopping centers located near the user or that the user typically goes to, or the like. In such examples, an AI model may be trained on search history data, wearable device data, location data, or other data obtained via the user device 220 and/or the IoT devices 438. The data may be annotated with actions of which the data is indicative. For example, a combination of location data, local climate data, and wearable device data may indicate that the user hikes and camps on the weekends in a relatively warm climate. As a result of the training the AI model and in response to inputting at least a portion of the first user data 432, the second user data 434, or the combination thereof in to the AI model, the AI model can output the consumer attributes 406 related to the actions of the user.

The first AI model(s) 404 may include any of the above-described AI models, and the consumer attributes 406 may include any of the above types of consumer attributes (e.g., the consumer attributes related to the appearance of the user, the interior design of the environment of the user, the actions performed by the user, and the clothing style characteristics of the user. Other types of consumer attributes may be generated by the first AI model(s) 404 or other AI models based on the first user data 432, the second user data 434, the user profile data 436, or a combination thereof in other examples. The retail integration system 104 may store the consumer attributes 406, the first user data 432, the second user data 434, the user profile data 436, the user profile 408, or a combination thereof in the consumer data repository 102.

Additionally, the consumer attributes 406 can be used by the retail integration system 104 to generate a user profile 408. The retail integration system 104 may further use information provided via, for example, user input to the software application 448 to generate the user profile 408. For example, the user profile data 436 may be used to generate the user profile 408. In some examples, the user profile 408 can be generated by an AI model in response to the AI model receiving the user profile data 436, the consumer attributes 406, or a combination thereof. The retail integration system 104 may also store the user profile 408 in the consumer data repository 102.

The retail integration system 104 can further generate and store the commerce-related data 442 indicative of a real-time inventory 402 of one or more retail entities. The retail entities may be organizations, companies, or the like that sell products. The commerce-related data 442 indicative of the real-time inventory 402 may be a list or data table that includes the products sold by and available for purchase from the retail entities. For the commerce-related data 442 to be indicative of the real-time inventory 402 of the retail entities, the commerce-related data 442 may be continuously updated. In some examples, the retail integration system 104 may communicate with inventory management systems of the retail entities to obtain the commerce-related data 442 (e.g., data related to stock levels of products, orders placed for the products, sales of the products, deliveries of the products, returns of the products, etc.). As a result, the retail integration system 104 may obtain up-to-date and accurate commerce-related data indicative of the real-time inventory 402 of the retail entities.

In some examples, the retail integration system 104 can access digital profiles of products sold by the retail entities. A digital profile of a product may include a digital model, such as a CAD model of the product. The digital profile may further include an identifier of the product (e.g., “couch”), a description of the product, key words associated with the product (e.g., color, a type of the product, etc.), a price of the product, sales information (e.g., how many times the product has been bought and how many of the product has been returned), or other information about the product. As such, the digital profiles may be used for comparing products. The digital profiles may further enable the retail integration system 104 to compare sales levels of products across different e-commerce platforms, retail entities, stores, store locations or the like.

Additionally, the retail integration system 104 may include a tracking subsystem 412 for tracking products. In some examples, a tracking device (e.g., an RFID tag or a GPS tracking device) may be affixed to the products to enable the tracking by the tracking subsystem 412. Additionally or alternatively, the tracking subsystem 412 may access cameras or other sensors to employ digital recognition of the products and may determine locations of the products based on locations of the cameras or other sensors. The commerce-related data 442 may be updated based on the tracking of the products. For example, based on tracking of a product 428, the retail integration system 104 can detect that the product 428 is positioned in a store location. The commerce-related data 442 can then be updated to indicate that the product 428 is available for purchase at the store location. In another example, based on the tracking of the product 428, the retail integration system 104 can detect that the product 428 is positioned in a distribution facility. The commerce-related data 442 can then be updated to indicate that the product 428 is available for purchase and shipping from the distribution facility.

The retail integration system 104 may further generate digital tokens for products (e.g., digital token 420 for product 428). The digital token 420 can uniquely identify the product 428 and can include product feature data 422 indicative of one or several attributes of the product. The product feature data 422 may be or be similar to the information in the digital profile. For example, the product feature data 422 may include an identifier (e.g., a name), shape, color, material, dimensions, price, and/or other data that may be related to physical characteristics of business characteristics of the product 428.

The commerce-related data 442 indicative of the real-time inventory 402 can include the digital token 420 for the product or can be based on the digital token 420 (e.g., can include the product feature data 422). In some examples, the commerce-related data 442, the digital token 420, the digital profile, or a combination thereof may be stored in blockchain to facilitate sharing of information and tracking of products (e.g., product 428). Alternatively, the commerce-related data 442, the digital token 420, the digital profile, or a combination thereof may be stored in the retail data repository 103.

The retail integration system 104 can then use the commerce-related data, digital tokens, digital profiles, or a combination thereof to generate commerce recommendations. For example, based on analysis of user data (e.g., first user data 432, second user data 434, and user profile data 436) and/or a user profile (e.g., user profile 408) and based on analysis of the commerce-related data 442 (e.g., the real-time inventory), a match can be determined. For example, based on the user data the retail integration system 104 may predict that the user often camps and has recently looked up information about single person tents. The prediction may be a consumer attribute output by a trained AI model of the retail integration system 104. The retail integration system 104 may then identify a store location within a threshold distance from the user that has a single person tent in stock. Thus, the retail integration system can determine a match between a consumer attribute and the real-time inventory of a retail entity. In response to determining the match, the retail integration system 104 may generate a commerce recommendation 426 with commerce (e.g., a product 428 for purchase) and transmit the commerce recommendation 426 to the user device 220.

In some examples a second AI model 424 may generate the commerce recommendation 426. The second AI model 424 may generate the commerce recommendation 426 in response to the retail integration system 104 inputting the commerce-related data 442, the consumer attributes 406, user data (e.g., the first user data 423, the second user data 434, and the user profile data 436), digital tokens, digital profiles, other consumer or product information, or a combination thereof into the second AI model 424. The second AI model 424 may be trained to identify a product and generate a commerce recommendation. For example, the AI-model 318 may be trained using a dataset of consumer attributes, user data, or other consumer information and commerce-related data or other product information. The dataset may then label the consumer and product information with corresponding product recommendations. The second AI model 424 can learn to recognize patterns and features associated with consumer information and product information as a result of the training. For example, the AI-model 318 may be able to identify a product to recommend based on one or more features of the product matching one or more consumer attributes. For example, a white sweater may match consumer attributes of local climate, clothing style, and color preference.

The second AI model 424 can also be continuously updated and refined by incorporating new data from retail entities (e.g., changes in the real-time inventory) and new data from users (e.g., an update to a consumer attribute based on new user data obtained), thereby improving the accuracy and adaptability of the second AI model 424 over time. This allows the AI-models to stay current with evolving retail entity inventory and user interests and preferences.

The commerce recommendation 426 may be output on a user interface of the user device 220. In some examples, the commerce recommendation 426 may be received at the user device 220 as a push notification from the software application 448. The commerce recommendation 426 may be received by the user device 220 in other forms in other examples.

In some examples, the retail integration system 104 can receive a user input 440. The user input 440 can indicate an intent of the user to purchase the product 428 recommended in the commerce recommendation 426. The user input 440 may be transmitted to the retail integration system 104 by the software application 448 as a result of a user selection of a purchase option on the user interface or by another means of the user indicating the intent to purchase the product 428.

In response to receiving the user input 440, the retail integration system 104 may control the user device 220 to facilitate a user purchase of the product 428. For example, the retail integration system may control the software application 448 to output, via user device, a store location 414 (e.g., an address of a closest store location with the product 428) and a position of the product 428 within the store location 414. A position of a product within a store location may be indicated by a section identifier, an aisle number, a shelf number, or other information that indicates where within a store location the product is located. In other words, the retail integration system 104 may transmit the store location and the position of the product 428 within the store location to the software application 448 to cause the software application 448 to generate and output the store location and the position of the product 428 within the store location at the user device 220.

In some examples, the retail integration system 104 may control the software application 448 to output, via the user device 220, a location of the user device 416. The retail integration system 104 may then generate set of directions 418 indicative of a route from the location of the user device to the store location 414 and may further control the software application 448 to output the set of directions via the user device 220. In some examples, the set of directions 418 may further include directions to the position of the product within the store location. For example, the set of directions 418 may indicate a fastest route from a front door of the store location 414 to the position on the product within the store location 414. In such examples, the software application 448 may output, via the user device 220 a map of the store location 414 that includes an indication of the location of the user device 416 and an indication of the position on the product 428 within the store location 414. Moreover, in some examples, the user may select an option associated with the store location 414 in the software application 448, and, as a result, be redirected to a navigation application to receive directions to the store location 414.

Additionally or alternatively, the retail integration system 104 may control the software application 448 to output, via the user device 220, a link 410 to an online store location associated with the product 428. As a result, the user may use the link to access the online store location and place an order for the product 428.

After the user purchase of the product 428, the retail integration system 104 can update the commerce-related data 442 to reflect the sale of the product 428. In some examples, the completion of the sale can include updating the blockchain to reflect ownership of the product by the user. Moreover, the retail integration system 104 may update the user data to reflect that the user purchased the product 428.

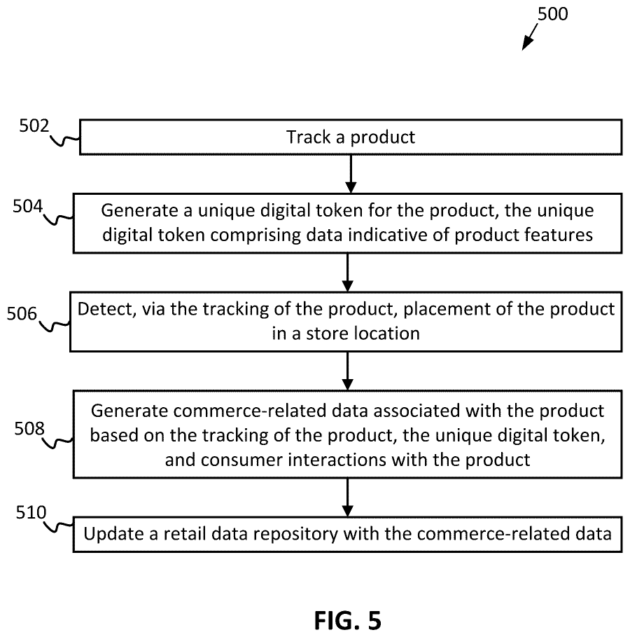

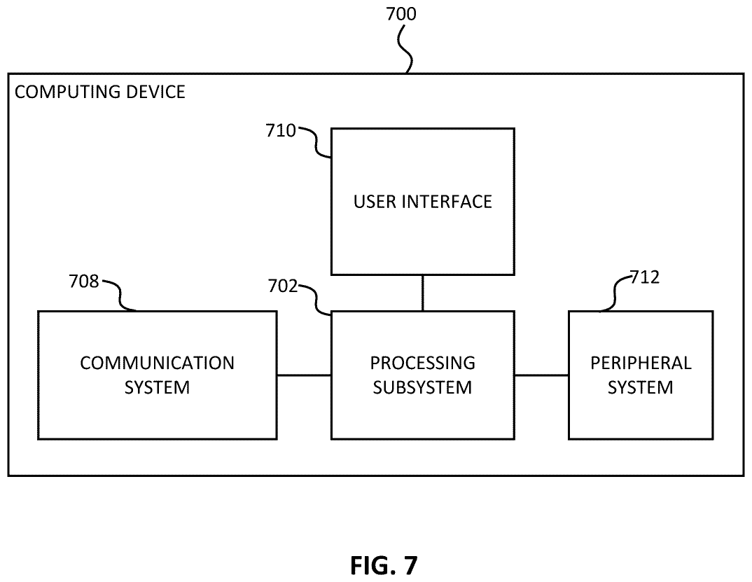

FIG. 5 is a flowchart of an example of a method 500 for integrating physical and digital shopping environments, in accordance with some embodiments of the present disclosure. In some examples, the processing subsystem 702 of FIG. 7 can perform one or more of the steps shown in FIG. 5. For example, the processing subsystem 702 may execute the retail integration system 104 to perform one or more of the steps shown in FIG. 5. In other examples, the processing subsystem 702 can implement more steps, fewer steps, different steps, or a different order of the steps depicted in FIG. 5. The steps of FIG. 5 are described below with reference to components discussed above in FIGS. 1A-4.

At block 502, the method 500 includes tracking a product 428. A tracking device (e.g., an RFID tag, NFC tag, Bluetooth enable tag, or a GPS tracking device) may be affixed to the product 428 to enable the tracking of the product 428. The retail integration system 104 may receive location data obtained via the tracking device. In a particular example, the product 428 is a brown, leather, sectional couch sold by a particular retail entity. Additionally, in the particular example, a tracking device (e.g., a GPS tracking device) may be affixed to the brown, leather, sectional couch while the couch is in a distribution location.

At block 504, the method 500 includes generating a digital token 420 for the product 428, the digital token 420 comprising data indicative of product features (e.g., product feature data 422). The digital token 420 can uniquely identify the product 428. That is, the digital token 420 may be a digital and unique representation of the product 428. The product feature data 422 may include information about the product. For example, the product feature data 422 may include an identifier of the product 428 (e.g., a name), a shape of the product 428, one or more colors of the product 428, one or more materials of the product 428, dimensions of the product 428, a price of the product 428, other data related to physical characteristics of business characteristics of the product 428, or a combination thereof. In the particular example, the product feature data 422 may include the material of the product 428 (e.g., leather), the type of product 428 (e.g., sectional couch), dimensions of the product 428, the color of the product 428 (e.g., brown), a price of the product 428, a name of the retail entity selling the product 428 and/or a brand of the product 428, etc.

In other examples, the method 500 may include generating the product feature data 422 without generating a digital token. Moreover, in other examples, the method 500 may include generating a digital profile that includes the product feature data 422 rather than a digital token.

At block 506, the method 500 includes detecting, via the tracking of the product 428, placement of the product 428 in a store location 414. In the particular example, the retail integration system 104 can receive location data from the GPS or other tracking device affixed to the brown, leather, sectional couch that indicates that the brown, leather, sectional couch was moved from the distribution location to the store location 414. Thus, the retail integration system 104 can detect the placement of the product 428 in the store location 414 based on the location data received. The distribution location may be a storage facility (e.g., a warehouse or other building) that stores and distributes products, while the store location 414 may be a physical space where the products can be sold directly to consumers.

The retail integration system 104 may further access cameras or other sensors at the store location 414 to employ digital recognition of the product 428. In doing so, the retail integration system 104 may determine a position of the product 428 within the store location 414. A position of a product within a store location may be indicated by a section identifier, an aisle number, a shelf number, or other information that indicates where within a store location the product is located.

At block 508, the method 500 includes generating commerce-related data associated with the product 428 based on the tracking of the product 428, the digital token 420, and consumer interactions with the product 428 or with similar products. In the particular example, the commerce-related data can include the location of the distribution facility, the location of the store location, information indicative of the position of the product 428 in the store location, or the like based on the tracking of the product 428. Additionally, the commerce-related data can include any product information or product feature data 422 available to the retail integration system 104. The retail integration system 104 may obtain the product information or product feature data 422 via the digital token, a website associated with the retail entity selling the product 428, another online location, or a combination thereof.

Moreover, the retail integration system 104 may receive data indicative of consumer interactions with the product 428 or with similar products based on a search history of the user obtained from one or more user devices. For example, the user may have searched for a leather couch and may have viewed similar products on a website associated with another retail entity. Thus, data associated with the search history or similar products may be included in the commerce-related data.

Additionally or alternatively, the consumer interactions may be of other users with the product. In such examples, the commerce-related data may include how many consumers have viewed the product on the website associated with the retail entity, how many consumers have bought the product, how many consumers have returned the product, or the like. Moreover, in such examples, the commerce-related data may include a rating of the product based on customer reviews, key words from consumer reviews (e.g., comfortable), or the like.

At block 510, the method 500 includes updating a retail data repository with the commerce-related data. For example, the commerce-related data generated for the brown, leather, sectional couch can be stored in the retail data repository 103. The retail data repository 103 may be organized such that the commerce-related data 442 is stored with similar products, in association the retail entity, or the like. In this way, the retail data repository 103 may be queried or otherwise accessed later by the retail integration system 104 in an efficient manner.

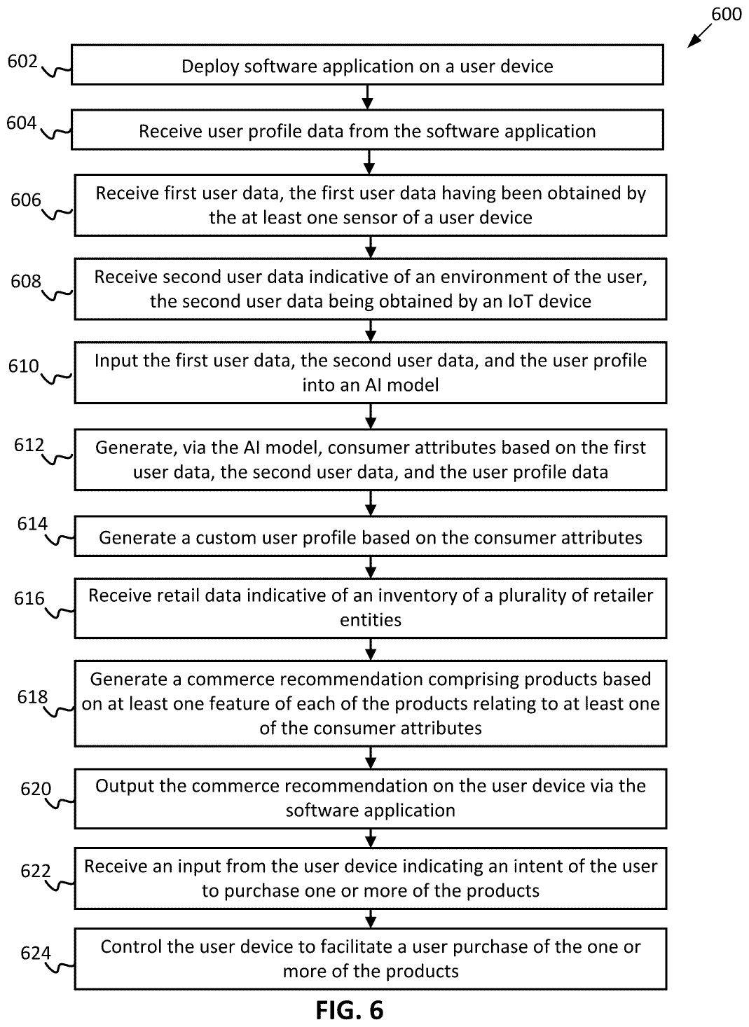

FIG. 6 is a flowchart of an example of a method 600 for integrating physical and digital shopping environments, in accordance with some embodiments of the present disclosure. In some examples, the processing subsystem 702 of FIG. 7 can perform one or more of the steps shown in FIG. 6. For example, the processing subsystem 702 may execute the retail integration system 104 to perform one or more of the steps shown in FIG. 6. In other examples, the processing subsystem 702 can implement more steps, fewer steps, different steps, or a different order of the steps depicted in FIG. 6. The steps of FIG. 6 are described below with reference to components discussed above in FIGS. 1A-4.

At block 602, the method 600 involves deploying a software application 448 on a user device 220. Examples of the user device 220 include a smart phone, a tablet, a personal computer, a laptop, other suitable devices, or a combination thereof. The software application 448 may provide a user of the user device 220 with access to features and functionality of the retail integration system 104.

At block 604, the method 600 involves receiving user profile data 436 from the software application 448. In a particular example, the user can create an account on the software application 448. In doing so, the user may provide personal data (e.g., a name, address, email, financial information such as income, etc.). The user may further provide information related to retail preferences. Information related to retail preferences may include brand preferences, product preferences, clothing style preferences, interior design style preferences (e.g., industrial, modern, contemporary, etc.), color preferences, interests of the user (e.g., sports, hobbies, music, or art the user enjoys), etc. The product preferences of the user may include types of products of interest to the user (e.g., chairs, t-shirts, etc.) or categories of products of interest to the user (e.g., patio furniture, professional clothing, etc. The clothing style preferences may include style preferences (e.g., preppy, casual, professional, etc.), fit preferences (e.g., fitted, relaxed, oversized, etc.), or other indications of types of clothes the user may desire. The user profile data 348 may therefore include the personal data, the information related to retail preferences, or other information input by the user to the software application 448 via the user device 220.

At block 606, the method 600 involves receiving first user data 432, the first user data 432 being obtained by the at least one sensor 446 of the user device 220. The first user data 432 may be related to an environment of the user. The environment of the user may be a part of a home of the user (e.g., a bedroom, closet, bathroom, kitchen, living room, or back yard), an office space used by the user, or another location in which the user device 220 can be positioned to obtain data.

The sensors 446 used to obtain the first user data 432 may include a camera, a microphone, or LiDAR sensors. In the particular example, the software application 448 may automatically and continuously obtain the first user data 432 captured via the sensors of the user device 220 and transmit the data to the retail integration system 104. Alternatively, the first user data 432 may be captured based on a user input (e.g., an uploading of video data or images to the software application 448). In another example, the user input may be a selection of an option in the software application 448 that causes the software application 448 to access the sensors 446 (e.g., the camera, microphone, or LiDAR sensors) and collect the first user data 432 (e.g., video data) of the environment of the user (e.g., of a home of the user). The user input that is the selection of the option in the software application 448 may enable the software application to access the sensors 446 and collect the first user data 432 for a pre-define period of time (e.g., up to 24 hours).

In a particular example, the environment of the user is a living room, and the first user data 432 includes video data and images of the living room obtained by a camera of the user device 220. Additionally, in the particular example, the first user data 432 also includes three-dimensional data obtained by using a LiDAR sensor of the user device 220 to scan the living room.

At block 608, the method 600 involves receiving second user data 434 indicative of the environment of the user, the second user data 434 being obtained by an IoT device. The IoT device may include a smart home device such as a smart thermostat, smart lock, smart appliance, and smart TV. Additionally, the IoT device may include a wearable device such as a fitness tracker or a smart watch, a personal-assistant device (e.g., Amazon Echo and Google Home), a connected vehicle, or the like. In the particular example, the second user data 434 may include location data and activity data collected by a wearable device (e.g., a smart watch) worn by the user.

At block 610, the method 600 involves inputting the first user data 432, the second user data 434, and the user profile data 436 into an AI model (e.g., first AI model 404). The AI model may be trained on data from IoT devices (e.g., activity data and location data), data from user devices (e.g., images of environments of users, videos of environments of users, and the like), user profile data (e.g., address, age, etc. of users). The data from the IoT devices and the data from the user devices can be annotated with metadata describing the data. For example, metadata corresponding to activity data may indicate a time of day during which the activity data was collected. In another example, a video of an environment can be annotated with metadata identifying the type of environment (e.g., living room or office). The data from the IoT devices and the data from the user devices can further be annotated with consumer attributes. For example, the activity data can be annotated with a workout (e.g., running or yoga). In another example, the video of the environment can be annotated with an interior design style of the environment, a list of colors indicative of a color palette for the environment, etc.

By training the AI model on activity data, location data, images of environments of users, videos of environments of user, and the like annotated with metadata and consumer attributes, the AI model can learn patterns and features of various types of data that are indicative of various consumer attributes.

Additionally, in some examples, the images, videos, or other data for the environments of users may be annotated with dimensions of the environment, dimensions of objects (e.g., furniture) in the environment, or a combination thereof. As a result, the AI model may learn to predict dimensions based on images, videos, or other data. Moreover, in some examples, the AI model may be trained on images, videos, or other data for the environments of users may be annotated with names of objects in the environments. As a result, the AI model may learn to detect missing objects in environments based on images, videos, or other data.

At block 612, the method 600 involves generating, via the trained machine learning model, consumer attributes based on the first user data 432, the second user data 434, and the user profile data 436. In the particular example, based on the first user data 432, the second user data 434, and the user profile data 436, the AI model may output the consumer attributes 406 related to interior design characteristics of the living room. For example, the consumer attributes 406 may include that living room is decorated in an industrial style with neutral colors. The AI model may further detect that the living room is missing a couch. Additionally, based on the user profile data (e.g., the address of the user and age) and second user data (e.g., location data), the machine learning model may output a prediction that the user works from home. Any of the information output by the machine learning model can be stored as the consumer attributes 406.

At block 614, the method 600 involves generating a user profile 408 based on the consumer attributes 406. Information provided via, for example, user input to the software application 448 (e.g., the user profile data 436) may also be used to generate the user profile 408. In some examples, the user profile 408 can be generated by another AI model in response to the AI model receiving the user profile data 436, the consumer attributes 406, or a combination thereof.

At block 616, the method 600 involves receiving commerce-related data 442 indicative of an inventory of a plurality of retail entities. The retail entities may be organizations, companies, or the like that sell products. The commerce-related data 442 indicative of the inventory may be a list or data table that includes the products sold by and available for purchase from the retail entities. The commerce-related data 442 may include the commerce-related data associated with the brown, leather, sectional couch described above with respect to FIG. 5.

At block 618, the method 600 involves generating a commerce recommendation 426 comprising product 428. The commerce recommendation may be generated based on at least one feature of the product 428 relating to at least one of the consumer attributes. Features of the product 428 may include any of the information included in the product feature data 422 or product information. Thus, in the particular example, based on the consumer attributes indicating that living room is decorated in an industrial style with neutral colors and that the living room is missing a couch, a commerce recommendation 426 may be generated that includes the brown, leather, sectional couch.

At block 620, the method 600 involves outputting the commerce recommendation on the user device via the software application. For example, the commerce recommendation 426 may received at the user device 220 as a push notification from the software application 448.

At block 622, the method 600 involves receiving a user input 440 from the user device 220 indicating an intent of the user to purchase the product. The user input 440 may be transmitted to the retail integration system 104 by the software application 448 as a result of a user selection of a purchase option on the user interface or by another means of the user indicating the intent to purchase the product 428.

At block 624, the method 600 involves controlling the user device to facilitate a user purchase of the product. For example, a store location 414 (e.g., an address of a closest store location with the product 428) and the position of the product 428 within the store location 414 may be output at the user device 220 via control of the software application 448. Additionally, a set of directions 418 may be generated that are indicative of a route from a location of the user device to the store location 414. The set of directions 418 may also be output at the user device 220 via control of the software application 448. Additionally or alternatively, a link to an online store location associated with the product 428 may be provided via control of the software application 448. As a result, the user may use the link 410 to access the online store location and place an order for the product 428

FIG. 7 is a block diagram of an example of a computing device 700 for integrating physical and digital shopping environments, in accordance with some embodiments of the present disclosure. For example, the computing device 700 can serve as the retail integration system 104, the user device(s) 220, the IoT device(s) 438, other components shown in FIGS. 1A-4, or a combination thereof. The computing device 700 can be implemented in various configurations in order to provide various functionality to a user. For example, the computing device 700 can be implemented as a server, a communication device (e.g., a smart phone, cellular phone, mobile phone, wireless phone, portable phone, radio telephone, etc.); a wearable device (e.g., a head-mounted device, smart eyeglasses, smart watch, and smart clothing); a home automation controller (e.g., controller for an alarm system, thermostat, lighting system, door lock, motorized doors, etc.); and/or other computing device (e.g., a tablet computer, phablet computer, notebook computer, laptop computer, etc.). The foregoing implementations are not intended to be limiting and the computing device 700 can be implemented as any kind of electronic or computing device that can be configured to perform a part of or all the operations disclosed herein (e.g., the operations described above with respect to FIGS. 6-7).

The computing device 700 includes processing subsystem 702 which can be implemented as one or more processors. The one or more processors can read one or more programs from the one or more memories and execute them using RAM. The one or more memories and RAM can be included in the memory system 704. The one or more processors can be of any type including but not limited to a microprocessor, a microcontroller, a graphical processing unit, a digital signal processor, an ASIC, a FPGA, a PLD, or any combination thereof. In some implementations, the one or more processors can include a plurality of cores, a plurality of arrays, one or more coprocessors, and/or one or more layers of local cache memory. The one or more processors can execute one or more programs stored in the one or more memories to perform the operations and/or methods, including parts thereof, disclosed herein.

The one or more memories can be non-volatile and can include any type of memory device that retains stored information when powered off. Non-limiting examples of memory include electrically erasable and programmable read-only memory (EEPROM), flash memory, or any other type of non-volatile memory. The one or more memories can include non-transitory computer-readable storage media from which the one or more processors can read instructions. A computer-readable storage medium can include electronic, optical, magnetic, or other storage devices capable of providing the one or more processors with computer-readable instructions or other program code. Non-limiting examples of a computer-readable storage medium include magnetic disks, memory chips, read-only memory (ROM), RAM, an ASIC, a configured processor, optical storage, or any other medium from which a computer processor can read the instructions.

The computing device 700 also includes storage system 706 which can be implemented as one or more storage devices. The one or more storage devices can be configured to store data received by and/or generated by the computing device 700. The one or more storage devices can be removable storage devices, non-removable storage devices, or a combination thereof. Examples of removable storage and non-removable storage devices include magnetic disk devices such as flexible disk drives and hard disk drives (HDDs), optical disk drives such as compact disk (CD) drives or digital versatile disk (DVD) drives, solid-state drives (SSDs), and tape drives.

The computing device 700 may further, in some examples, include a user interface system 710. User interface system 710 can include one or more devices configured to display images, video, and other content and receive input from a user of the computing device 700. Examples of devices included in the user interface system 710 include a liquid crystal display, a light emitting diode display, an organic light emitting diode display, a projector display, a touchscreen display, and the like.

The computing device 700 also includes communication system 708. Communication system 708 can include one or more devices configured to enable the computing device 700 to communicate with various wired or wireless networks and other systems and devices. Examples of devices included in communication system 708 include wireless communication modules and chips, wired communication modules and chips, chips for communicating over local area networks, wide area networks, cellular networks, satellite networks, fiber optic networks, and the like, systems on chips, and other circuitry that enables the computing device 700 to send and receive data.

The computing device 700 also includes a peripheral system 712. Peripheral system 712 can include one or more subsystems configured to provide various functionality to the computing device 700. Examples of subsystems included in peripheral system 712 include a sensor subsystem, an audio subsystem, a power subsystem, an orientation subsystem, and input/output subsystem.

The sensor subsystem can include one or more devices configured to transmit and receive various signals (e.g., light, ultrasonic, radar, lidar, and the like) that can be used for sensing an environment surrounding the computing device 700. Examples of devices included in the sensor subsystem include digital and electronic cameras, light field cameras, 3D cameras, image sensors, imaging arrays, ultrasonic sensors, radar sensors, range sensors, LiDAR sensors, and the like.

The audio subsystem can include one or more devices configured to record sounds from an environment surrounding the computing device 700 and output sounds to the environment surrounding the computing device 700. Examples of devices included in audio subsystem include microphones, speakers, and other audio/sound transducers for receiving and outputting audio signals and other sounds.

The power subsystem can include one or more components configured to provide power to the computing device 700. Examples of components included power subsystem include batteries, power supplies, charging circuits, solar panels, and other components that can be configured to receive power from a source external to the computing device 700 or generate power and power the computing device 700 with the received or generated power.

The orientation subsystem can include one or more devices configured to determine an orientation and posture of the computing device 700 and users of the computing device 700. Examples of devices included orientation subsystem include global positioning system (GPS) receivers, ultra-wideband (UWB) positioning devices, Wi-Fi positioning devices, accelerometers, gyroscopes, motion sensors, tilt sensors, inclinometers, angular velocity sensors, gravity sensors, and inertial measurement units, and the like.

The computing device 700 can also include other input/output (I/O) components (not shown). Examples of such input components can include a mouse, a keyboard, a trackball, a touch pad, a touchscreen display, a stylus, data gloves, and the like. Examples of such output components can include holographic displays, 3D displays, projectors, and the like.

The foregoing configurations of the computing device 700 are not intended to be limiting and the computing device 700 can include other devices, systems, and components.

Although specific examples have been described, various modifications, alterations, alternative constructions, and equivalents are possible. Examples are not restricted to operation within certain specific data processing environments but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. A computer-implemented method comprising:
receiving commerce-related data;
receiving user data, the user data having been obtained by at least one sensor of a user device;
inputting the user data into an AI model;
generating, via the AI model, at least one consumer attribute based on the user data; and
generating a commerce recommendation comprising one or more products, the commerce recommendation being generated based on at least one feature of each of the one or more products relating to the at least one consumer attribute.

2. The computer-implemented method of claim 1, wherein the user data is first user data and the computer-implemented method further comprises:
receiving second user data indicative of an environment of the user, the second user data being obtained by an IoT device in the environment of the user;
inputting the first user data and the second user data into the AI model; and
generating, via the AI model, the at least one consumer attribute based on the first user data and the second user data.

3. The computer-implemented method of claim 2, further comprising:
deploying a software application on the user device;
receiving user profile data from the software application;
inputting the first user data, the second user data, and the user profile data into the AI model; and
generating, via the AI model, the at least one consumer attribute based on the first user data, the second user data, and the user profile data.

4. The computer-implemented method of claim 3, further comprising:
outputting the commerce recommendation on the user device via the software application.

5. The computer-implemented method of claim 1, further comprising:
receiving an input from the user device indicating an intent of the user to purchase a product of the one or more products; and
in response to receiving the input, controlling the user device to facilitate a user purchase of the product.

6. The computer-implemented method of claim 5, wherein controlling the user device to facilitate the user purchase of the product comprises:
controlling a software application executing on the user device to output, via the user device, a position of the product within a store location.

7. The computer-implemented method of claim 6, further comprising:
controlling the software application to output, via the user device, a location of the user device;
generating a set of directions indicative of a route from the location of the user device to the location of the product within the store location; and
controlling the software application to output the set of directions via the user device.

8. The computer-implemented method of claim 5, wherein controlling the user device to facilitate the user purchase of the product comprises:
controlling a software application executing on the user device to output, via the user device, a link to an online store location associated with the product.

9. The computer-implemented method of claim 1, further comprising:
tracking each of the one or more products;
generating a digital token for each of the one or more products, the digital token comprising data indicative of the at least one feature of each of the one or more products; and
generating commerce-related data associated with the one or more products based on the tracking of the one or more products and based on the data indicative of the at least one feature of each of the one or more products, wherein the commerce-related data receiving comprises the commerce-related data associated with the one or more products.

10. The computer-implemented method of claim 1, further comprising:
generating a user profile for the user based on the at least one consumer attribute.

11. A system comprising:
one or more processors; and
one or more memories storing instructions that, upon execution by the one or more processors, configure the system to perform operations comprising:
receiving commerce-related data;
receiving user data, the user data having been obtained by at least one sensor of a user device;
inputting the user data into an AI model;
generating, via the AI model, at least one consumer attribute based on the user data; and
generating a commerce recommendation comprising one or more products, the commerce recommendation being generated based on at least one feature of each of the one or more products relating to the at least one consumer attribute.

12. The system of claim 11, wherein the user data is first user data and the operations further comprise:
receiving second user data indicative of an environment of the user, the second user data being obtained by an IoT device in the environment of the user;
inputting the first user data and the second user data into the AI model; and
generating, via the AI model, the at least one consumer attribute based on the first user data and the second user data.

13. The system of claim 12, wherein the operations further comprise:
deploying a software application on the user device;
receiving user profile data from the software application;
inputting the first user data, the second user data, and the user profile data into the AI model; and
generating, via the AI model, the at least one consumer attribute based on the first user data, the second user data, and the user profile data.

14. The system of claim 13, wherein the operations further comprise:
outputting the commerce recommendation on the user device via the software application.

15. The system of claim 11, wherein the operations further comprise:
receiving an input from the user device indicating an intent of the user to purchase a product of the one or more products; and
in response to receiving the input, controlling the user device to facilitate a user purchase of the product.

16. The system of claim 15, wherein the operation of controlling the user device to facilitate the user purchase of the product comprises:
controlling a software application executing on the user device to output, via the user device, a position of the product within a store location.

17. One or more computer-readable storage media storing instructions that, upon execution by one or more processors, cause operations comprising:
receiving commerce-related data;
receiving user data, the user data having been obtained by at least one sensor of a user device;
inputting the user data into an AI model;
generating, via the AI model, at least one consumer attribute based on the user data; and
generating a commerce recommendation comprising one or more products, the commerce recommendation being generated based on at least one feature of each of the one or more products relating to the at least one consumer attribute.

18. The one or more computer-readable storage media of claim 17, wherein the user data is first user data and the operations further comprise:
receiving second user data indicative of an environment of the user, the second user data being obtained by an IoT device in the environment of the user;
inputting the first user data and the second user data into the AI model; and
generating, via the AI model, the at least one consumer attribute based on the first user data and the second user data.

19. The one or more computer-readable storage media of claim 18, wherein the operations further comprise:
deploying a software application on the user device;
receiving user profile data from the software application;
inputting the first user data, the second user data, and the user profile data into the AI model; and
generating, via the AI model, the at least one consumer attribute based on the first user data, the second user data, and the user profile data.

20. The one or more computer-readable storage media of claim 19, wherein the operations further comprise:
outputting the commerce recommendation on the user device via the software application.
